(19) United States
(12) Patent Application Publication
(10) Pub. No.: US 2013/0231194 A1
(43) Pub. Date: Sep. 5, 2013

(54) OFFLINE GAME STORING SYSTEM AND METHOD THEREOF

(71) Applicants: Xin Wang, Nanshan DIstrict (CN); Zhi-Jianz Zhong, Nanshan District (CN); Cheng-Cong Xia, Nanshan District (CN)

(72) Inventors: Xin Wang, Nanshan DIstrict (CN); Zhi-Jianz Zhong, Nanshan District (CN); Cheng-Cong Xia, Nanshan District (CN)

(21) Appl. No.: 13/885,718

(22) PCT Filed: Sep. 8, 2011
(86) PCT No.: PCT/CN2011/079457

§ 371 Date: May 16, 2013

(30) Foreign Application Priority Data
Nov. 24, 2010 (CN) 201010576197.5

(51) Int. Cl. A63F 13/10

(52) U.S. Cl. CPC A63F 13/10
USPC 463/43

(57) ABSTRACT

An offline game storing system and a game progress storing method of an offline game are disclosed. The offline game storing system comprises a client and a server, wherein a management server in the server receives a request from the client for uploading or downloading a game progress file, stores an uploaded game progress file to a game progress storage server, or sends a game progress file corresponding to the downloading request in the game progress storage server to the client. The game progress storing method comprises the following steps: a progress file of the offline game is uploaded to a server, or a game progress file is downloaded from the server and the offline game is played according to the progress file. A user may play the offline game on different computers by using a same game progress, and since a cloud storage technology is adopted, the loading of the server is reduced and the manner of managing stored files in the server has the strong disaster tolerance capability, thereby ensuring the safety and stability of the server.

This application claims the right of the priority of Chinese patent application No. 201010576197.5, entitled “Offline Game Storing System and Method Thereof”, and filed on Nov. 24, 2010. The entire contents thereof are herein incorporated by reference.

### FIELD OF THE INVENTION

The present invention relates to the technical field of offline games, and more particularly, to an offline game storing system and a storing method thereof.

### DESCRIPTION OF THE PRIOR ART

The offline game is a game that can be independently run on a computer or a certain game platform with running progresses. There is currently another type of games opposite thereto, named the network game. The network game, also called the online game (abbreviated as OLG), is usually referred to as a game in which multiple players can interact for entertainment over the computer network, and is classified into various types like game of strategy, game of action, game of athletics, game of fistfight, game of music, game of speed, game of webpage and game of role play, etc. Of course, there are also some online single-player games. For a network game, the multiple players must access to the internet, and running of the game requires the support of dedicated servers and networks. Accordingly, the major distinction between an offline game and a network game is that the offline game can be normally run without accessing to the internet, that the offline game does not require any dedicated server during running, that the mode of the offline game is mostly human-versus-machine, and that progresses of the offline game are kept on file by storing a progress file into the local hard disk of a computer, thereby the game can proceed following the progress of the previous running by reading the progress file stored after the previous running.

However, since the files of the currently available offline games are all locally stored, the storing mode is severely defective because the files of a game cannot be synchronized—that is to say, after running an offline game and a corresponding progress file stored on a computer, it is impossible to read the progress file of the game on the computer when the user runs the same offline game on another computer, so that it is impossible to run the offline game in continuation with the progress on the previous computer, and the game has to be run anew or from the progress of the current computer. Therefore, offline games are currently relatively inferior in terms of interactivity and flexibility.

### SUMMARY OF THE INVENTION

The technical problem to be solved by the present invention is to provide an offline game storing system and a storing method thereof with respect to deficiencies of the prior art, to realize synchronization of the stored progress files, whereby the user is enabled to start from the progress of the previous running when the same offline game is run on different game platforms.

In order to solve this technical problem, one embodiment of the present invention provides an offline game storing system, comprising a client and a server, wherein the client independently runs the offline game and the server comprises a management server and a game progress storage server, the management server interacts with the client to receive a request from the client for uploading or downloading a game progress file of the offline game, and the management serve further stores an uploaded game progress file to the game progress storage server, or sends a game progress file in the game progress storage server to the client corresponding to the downloading request.

Another embodiment of the present invention further provides a method for storing a game progress file of an offline game, the method comprises the following steps: Step 11: a client sends a request for uploading a game progress file to a server; step 12: the client calculates on the game progress file to obtain identification information of the game progress file, and sends to the server the game progress file and its identification information if the client is allowed to upload the game progress file by the server; and step 13: a management server of the server receives the game progress file and its identification information, and stores the uploaded game progress file to a game progress storage server when receiving a request from the client for uploading the game progress file of the offline game.

In step 11, the uploading request comprises game information and user information sending the uploading request through the client.

In step 12 of the aforementioned method, the client compresses the game progress file before calculating on it, and calculates the compressed game progress file to obtain the identification information; when the offline game is a flash offline game, the compressing of the game progress file comprises compressing the game progress file from a flash game storing location. Moreover, the calculating on the compressed game progress file is hashing calculating, and the identification information obtained is a hash value.

Step 13 of the aforementioned method comprises the following steps: Step 131: the server receives the game progress file and its identification information, stores the received identification information to a user information database, and divides the game progress file into blocks; step 132: storing each block to a node server cluster; and step 133: storing storage information of each block to an index server.

A third embodiment of the present invention further provides a method for obtaining a game progress file of an offline game, the method comprises the following steps: Step 21: a client sends downloading request information for a game progress file to a management server of a server, wherein the downloading request information comprises a download address of the game progress file to be obtained, and the download address comprises identification information of the game progress file; step 22: the server parses the downloading request to obtain the download address and the identification information of the game progress file; step 23: the server obtains storage information of each block of the game progress file according to the identification information; step 24: obtaining each block of the game progress file according to the storage information, and merging the blocks into a complete game progress file; and step 25: when the management server receives the downloading request from the client for the game progress file of the offline game, the complete game progress file corresponding to the downloading request in a game progress storage server is sent to the client.

By virtue of the system and methods provided by the embodiments of the present invention, firstly, users can play an offline game with the same progress of the offline game on different computers to realize synchronization of game progress files and improvement of interactivity and flexibility of the offline game. Secondly, since the offline game storing system provided by the embodiments of the present invention employs compression and decompression of file data, tcp private protocol and special document storage methods, the loading of the server is reduced, and disaster tolerance capability of the server is improved, thereby ensuring the safety and stability of game running.

Technical solutions of the present invention will be described in greater detail below with reference to accompanying drawings and specific embodiments.

### BRIEF DESCRIPTION OF THE DRAWINGS

FIG. 1 is a framework chart illustrating the structure of an offline game storing system according to an embodiment of the present invention;

FIG. 2 is a flowchart illustrating a storing method of the offline game according to an embodiment of the present invention;

FIG. 2a is a flowchart illustrating a storing method of the flash offline game according to an embodiment of the present invention;

FIG. 3 is a flowchart illustrating uploading of a game progress file by the offline game storing system according to an embodiment of the present invention; and

FIG. 4 is a flowchart illustrating downloading of a game progress file by the offline game storing system according to an embodiment of the present invention.

### DETAILED DESCRIPTION

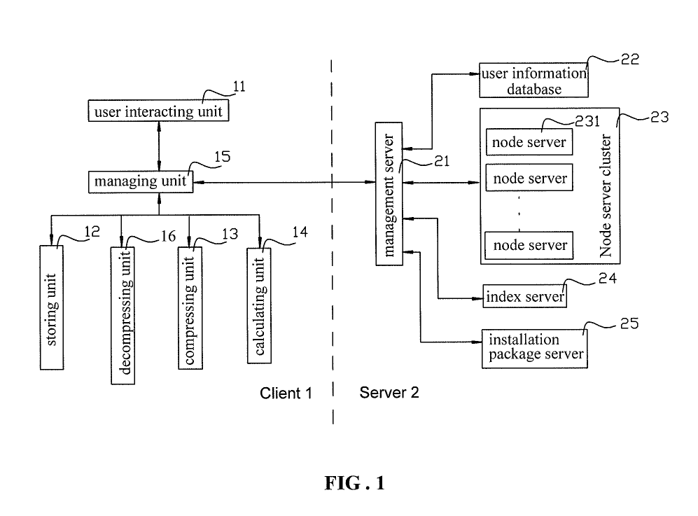

FIG. 1 is a framework chart illustrating the structure of an offline game storing system according to an embodiment of the present invention. As shown in FIG. 1, the offline game storing system according to an embodiment of the present invention comprises a client 1 and a server 2. The client 1 may be installed on any of such game platforms as a computer, a mobile communication device, and a personal digital assistant, etc., to provide running environment for the running of the offline games. The client 1 comprises a user interacting unit 11, a storing unit 12, a compressing unit 13, a calculating unit 14, a managing unit 15 and a decompressing unit 16. The user interacting unit 11 may be designed as a main interface of the system in practical application, and the user may input various information and requests via the main interface, and may run the offline game on the main interface. For instance, the user may register or log-in via the main interface, send a request for downloading a certain progress file of a game when the game is running, or send a request for uploading a game progress file when a game has been run. On one hand, the managing unit 15 is connected to the user interacting unit 11, receives and processes information or requests input via the user interacting unit 11; if user registration information is input, the received user registration information, such as user ID, password, e-mail address and the like, is sent to the server 2; and if a request of a user for downloading a certain game progress file of a certain game is received by the managing unit 15, the request is sent to the server 2; if a request of a user for uploading a certain game progress file of a certain game is received by the managing unit 15, the managing unit 15 processes the game progress file to obtain identification information of the game progress file, and subsequently sends the game progress file and its identification information to the server 2. On the other hand, the managing unit 15 interacts with the server 2 to receive messages and downloaded game progress files from the server 2.

Moreover, the managing unit 15 stores game progress files of an offline game, which is currently being run, to the storing unit 12 in real-time, wherein the storing unit 12 may be specifically embodied as a local hard disk.

When the user inputs a request for uploading a certain game progress file of a certain game via the user interacting unit 11, the managing unit 15 processes the game progress file. A specific embodiment for such processing is as follows: firstly sending the game progress file to the compressing unit 13 for compression, and thereafter calculating the compressed game progress file by the calculating unit 14 to obtain identification information for identifying the game progress file—for instance, the calculating unit 14 performs a hash calculation, and the identification information obtained is a hash value. Then, the compressed game progress file and the identification information (such as a hash value) are sent to the server 2 via the managing unit 15. After the managing unit 15 receives the compressed file of the game progress file sent from the server 2, the compressed file is decompressed by the decompressing unit 16.

The server 2 comprises a management server 21, a user information database 22, a node server cluster 23, an index server 24, and an installation package server 25. The client 1 is connected, by means of wired or wireless connection, to the management server 21, and the management server 21 is connected to the user information database 22, the node server cluster 23, the index server 24, and the installation package server 25, respectively.

The management server 21 interacts with the managing unit 15, receives various information and uploading or downloading requests sent from the managing unit 15, and makes corresponding processes. The user information database 22 stores therein detailed documents of registered users and information uploaded to the node server cluster 23, including but not limited to identification information (such as hash values) corresponding to various game files, file descriptions, file storing time and download addresses, etc., wherein the download addresses comprise hash values or information converted from the hash values. Accordingly, progress files can be definitely obtained via the download addresses. The node server cluster 23 comprises a plurality of node servers 231, each of which stores therein data blocks with a certain size (64 kb, for example) divided from a game file by the use of the cloud storage technology. The index server 24 is used to store storage index information of each game progress file, wherein the storage index information of each game progress file comprises the hash value of the game progress file, the number of each block of the game progress file, and the specific storage address of each block (the number of the node server, for example). The installation package server 25 stores therein various installation packages of offline games that can be run in the environment provided by the client 1.

The user may download installation packages of game clients from websites that provide progress storing services of offline games or various downloading websites, and install on such terminals as a computer, a mobile communication device (such as a mobile phone) and the like that serve as platforms to run the game.

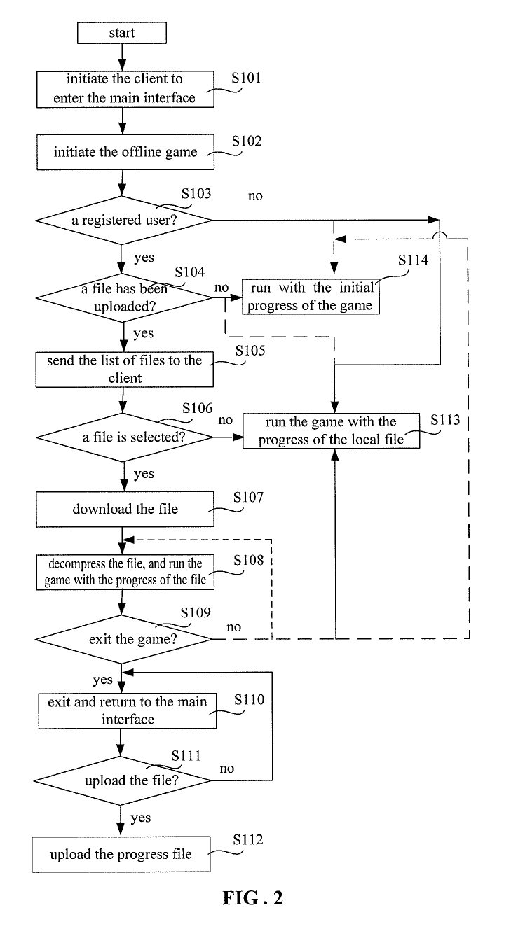

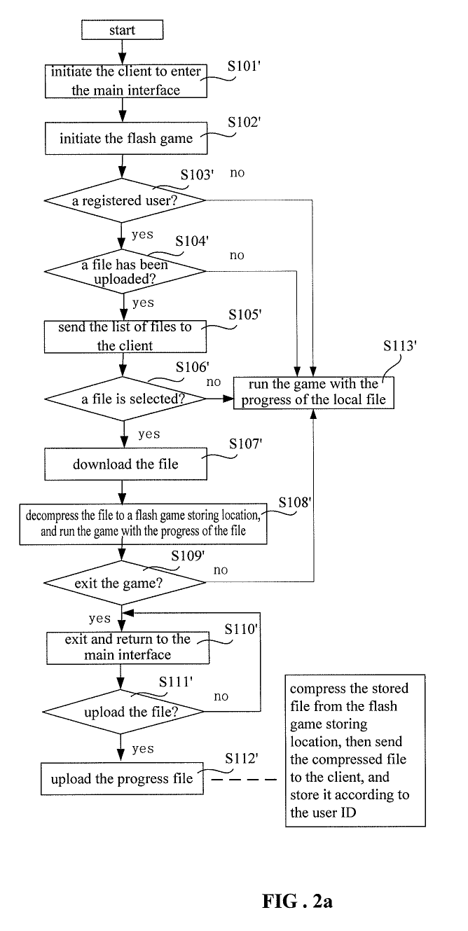

FIG. 2 is a flowchart illustrating a storing method of the offline game according to an embodiment of the present invention. The system and method according to the embodiment of the present invention are described in greater detail below with reference to combination of FIG. 2 and FIG. 1.

Step S101: the client 1 is initiated to enter the main interface (the user interacting unit 11) of the client. As should be explained, when the user logs in the main interface for the first time, the user ID should be registered and such corresponding registration information as password and email address should be filled in via the main interface. IDs of registered users and other relevant documents are sent by the managing unit 15 of the client 1 to the management server 21, by which these information are stored to the user information database 22.

If the user runs an offline game for the first time, the client 1 downloads the required offline game from the game installation package server 25 through the management server 21.

Step S102: the user selects and runs the offline game with storing functions at the main interface. When the user clicks on the main interface to initiate a certain offline game, the request of the user for initiating the offline game is received by the managing unit 15 of the client 1, user information (such as the user ID), a game ID (one game corresponds to one ID) and a request information indicating start of the game are merged into one piece of information (hereinafter referred to as “game starting request”) and sent to the management server 21.

Step S103: after the management server 21 receives the game starting request sent from the managing unit 15, the identity of the user is verified according to the user information contained in the request; if the user is not a registered user, a response information is sent to the managing unit 15 to inform the identity of the user, in which case the files of the game run by the user are not uploaded and stored, and the previous files are not downloaded to the user, and step S113 is thereafter performed; in step S113, a local game progress file is read, and the game is started with the progress of the local file; if there is no local progress file of the game, the game starts from the initial progress, the process goes to step S114; if the user is a registered user, step S104 is performed.

Step S104: the management server 21 queries in the user information database 22 according to the game ID (one ID corresponds to one game) in the request whether the user has uploaded any progress file of the offline game corresponding to the game ID; if the user has uploaded the progress file, the process goes to step S105; if not, step S113 is performed; in step S113, the managing unit 15 reads a local game progress file, and the game is started with the progress of the local file; if there is no local progress file of the game, the game starts from the initial progress, the process goes to step S114.

Step S105: the management server 21 sends file identifications (such as file descriptions, upload time, download addresses, etc.) of all or partial (the latest three, for example) history files of the offline game stored in the user information database 22 in the form of a list to the client 1, and the list is displayed via the main interface to the user for selection.

Step S106: determining whether the user has selected a game progress file via the client 1 or not. If the user has selected one, the process goes to step S107; if not, the process goes to step S113, in which a local game progress file is read, and the game is run with the progress of the local file.

Step S107: the management server 21 obtains the game progress file from the node server cluster 23 based on the download address in the file identification sent from the client 1 and sends it to the client 1. The processing process recited in this step is actually a process of downloading the file, and the flow of the downloading process will be described in detail in the following, while further description is omitted here.

Step S108: the game progress file sent from the management server 21 is decompressed, and the offline game is thereafter run with the progress.

In addition, during the running of a game, the client 1 can store the progresses of the running game in real-time, the user can also take storing operation on his or her own initiative, and the stored files are all stored in the local storing unit 12.

Step S109: when a game is playing, the user may determine to exit the game at any time; if it is determined to exit, the process goes to step S110; if not, the process returns to step S108 or S114, S113 to continue.

Step S110: exiting the offline game currently running and returning to the main interface.

Step S111: the user selects on the main interface whether to upload game progress files; if it is selected to upload the game progress, the process goes to step S112; if not, the process returns to step S110, and keeps staying on the main interface.

Step S112: when the user selects to upload the game progress files, the managing unit 15 of the client 1 sends an uploading request to the management server 21, and the management server 21 employs the cloud storage technology to store the game progress files formed at the end of the game to the node server cluster 23. The uploading flow of this step will be described in detail in the following, while no further description is made here.

Offline games mainly involve program-executable offline games (*.exe), and also comprise flash offline games (*.flash) and other small games. The two types of offline games are slightly different in the locations of local files, for example, the storing location of a program-executable offline game may be the directory of the game, a location specified in the hard disk, or a public storage location, while the storing location of a flash offline game can only be a designated flash game storing location, and this location is different from the storing location of the program-executable offline game.

FIG. 2a is a flowchart illustrating a storing method of the flash offline game according to an embodiment of the present invention. FIG. 2a is essentially the same as FIG. 2 in principles, and merely particularizes several steps in view of the characteristics of the flash offline game. The portions of FIG. 2a identical with those of FIG. 2 are not described in detail. As shown in FIG. 2a, S101′-5107′ respectively correspond to S101-S107 in FIG. 2.

S108′: this step is a particularization about S108 in FIG. 2; for a flash offline game, when a file is downloaded, the file needs to be decompressed to a flash game storing location, and the game is run with the progress of this file.

In addition, during running of a flash offline game, the client 1 can store the progresses of the running game in real-time, and the user can also take storing operation on his or her own initiative, and store the real-time stored files to the flash game storing location.

S109′-S111′ respectively correspond to S109-S111 in FIG. 2.

S112′: this step is a particularization about S112 in FIG. 2; for a flash offline game, when a stored file is uploaded, the file needs to be compressed from a flash game storing location before the file is sent to the server, and is then stored by the server according to the user ID.

S113′ corresponds to S113 in FIG. 2.

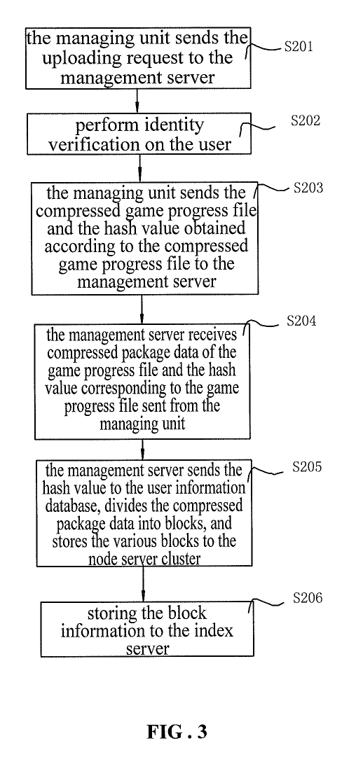

FIG. 3 is a flowchart illustrating uploading of a game progress file by the offline game storing system according to an embodiment of the present invention. As shown in FIG. 3 in conjunction with FIG. 1, the step S112 specifically comprises the following steps.

Step S201: when the user selects to upload a progress file of the current game via the main interface, the managing unit 15 sends to the management sever 21 an uploading request that comprises such information as the user information, the user ID and the file description and file storing time of the progress file.

Step S202: the management server 21 verifies the identity of the user via the information in the user information database 22, and sends a message allowing or forbidding the uploading to the managing unit 15. Uploading is possible only when the user is verified as a legal user, i.e., a registered user, and such information as the file description and file storing time of the game progress file can be stored to the user information database; if the user is not a registered user, uploading is forbidden and the uploading process is terminated.

Step S203: when the client sending the uploading request is a legal user, the managing unit 15 sends the desired game progress file stored in the storing unit 12 to the compressing unit 13 for compression, the calculating unit 14 calculates a hash value that corresponds to the game progress file according to the content of the compressed file, and the managing unit 15 sends the compressed game progress file and the hash value calculated on the basis of the compressed game progress file to the management server 21. Since the hash value is calculated according to the content of the game progress file, it can be used as a unique identification of the game progress file.

Step S204: the management server 21 receives compressed package data of the game progress file and the hash value that corresponds to the game progress file sent from the managing unit 15.

Step S205: the management server 21 stores the received hash value to the user information database 22, divides the compressed packet into blocks with a unit of a certain size (such as 64 kb), and stores the blocks to different node severs 231, respectively.

In step S204, after the management server 21 receives the compressed package data, the management server 21 calculates a hash value according to the received compressed package data, and compares the hash value with the one stored in the user information database 22 which was uploaded together with the compressed package data. If the two hash values are identical, this indicates that the uploading is successful; if the two hash values are different, this indicates that the received file is not the file desired to be uploaded by the client due to such circumstances in which network connection was failed or the client 1 was closed perforce during the uploading process, in which case the management server 21 would delete the compressed packet and the relevant data as received, such as the hash values and file descriptions stored to the user information database, instead of storing them.

Step S206: the management server 21 stores the hash value that corresponds to the file, and the block information to the index server 24, wherein the block information comprises block numbers and storage addresses that correspond to the various blocks, such as the numbers of the node servers 231.

The management server 21 stores file download addresses for each of the uploaded files in the user information database for use in downloading the files. Wherein the file download addresses comprise hash values and some other auxiliary information to enable the client to uniquely obtain the desired file.

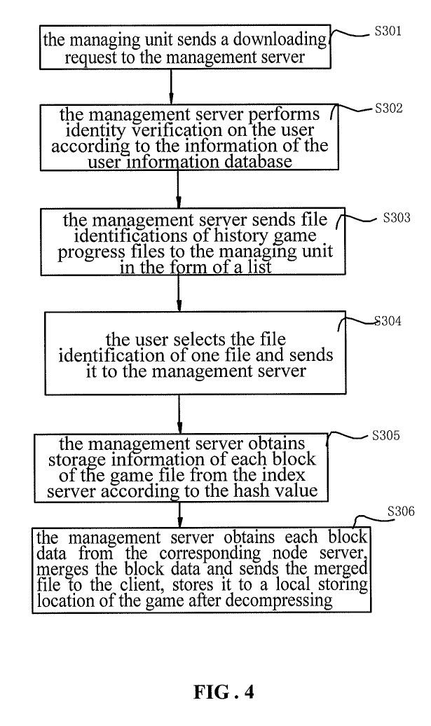

FIG. 4 is a flowchart illustrating downloading of a game progress file by the offline game storing system according to an embodiment of the present invention. As shown in FIG. 4 in conjunction with FIG. 1, the downloading process recited in the foregoing step S107 is as follows.

Step S301: the managing unit 15 of the client 1 sends to the management server 21 a downloading request that comprises user information and game information; on receiving the downloading request, the management server 21 parses the downloading request and obtains the ID of the user and the game ID required to be downloaded.

Step S302: the management server 21 performs identity verification to the user via information in the user information database 22; if the identity is legal, the process goes to the next step S303; if the identity is illegal, obtainment of the game progress file of the offline game is terminated.

Step S303: the management server 21 sends to the client 1 file identifications (including file descriptions, file storing time and file download addresses) of the latest three game progress files with respect to the user in the form of a list.

Step S304: when the user selects one of the file identifications (i.e., a download address of one file) from the list, the managing unit 15 in the client sends the information of the selected file identification, at least the download address and the request relevant to the downloading, to the management server 21 in the server.

Step S305: the management server 21 obtains storage information of each block of the game progress file from the index server 24 according to the hash value in the download address.

Step S306: data of the blocks are obtained from the corresponding node servers 231 according to the block numbers and the corresponding node server numbers in the storage information, merged and sent by the management server 21 to the managing unit 15 of the client 1; since the file is a compressed file, the managing unit 15 decompresses the compressed file to a local storing location of the game after successfully receiving the file,

During uploading and downloading of the game progress files in the offline game storing system according to the abovementioned embodiments of the present invention, when a game progress file is uploaded, the management server 21 can divide the file into blocks after completely receiving the file or divide while receiving, for example, divide the compressed package data with a unit of a size of 64 kb while receiving the compressed package data, and subsequently store each block data to the node server cluster 23.

In summary, as compared with offline games in the prior art, the offline game storing system provided in the embodiments of the present invention employs two game progress storing modes: a first mode storing locally, and a second mode storing at the server; the second mode employs data compression, decompression, the tcp private protocol and the “cloud storage”, and possesses the following advantages: firstly, the user may play a game on different computers with a same game progress of the offline game; secondly, since the file to be stored is divided into blocks and each block is stored in at least three servers, loading of the servers is reduced, and the mode of managing stored files in servers has strong disaster tolerance capability, thereby ensuring the safety and stability of the servers.

1. An offline game storing system, comprising:
a client independently runs an offline game; and
a server comprises a management server and a game progress storage server;
wherein the management server receives a request from the client for uploading or downloading a game progress file of the offline game, and stores the uploaded game progress file to the game progress storage server or sends the requested game progress file stored in the game progress storage server to the client; and
wherein the game progress file comprises progress of the offline game played by a user and enables the user to continue the progress of the offline game on a computing device different from the client.

2. The offline game storing system as recited in claim 1, wherein the game progress storage server comprises a node server cluster and an index server, the node server cluster comprises a plurality of node servers; wherein the node server cluster and the index server are respectively connected to the management server, the node server cluster stores blocks of the game progress file, and the index server stores storage information in the node server cluster of each block of the game progress file.

3. The offline game storing system as recited in claim 1, wherein the server further comprises a user information database storing user information and file download addresses of game progress files, wherein the file download addresses comprise hash values obtained by hash calculations based on the game progress files.

4. The offline game storing system as recited in claim 1, wherein the server further comprises an installation package server storing an installation package of the offline game.

5. The offline game storing system as recited in claim 1, wherein the client comprises a user interacting unit and a managing unit, the user interacting unit provides at least user information and requests to the managing unit, and the managing unit carries out information interaction and processing with the user interacting unit and the management server, respectively; the client further comprises a calculating unit that calculates on a game progress file to be uploaded to obtain identification information of the game progress file.

6. The offline game storing system as recited in claim 5, wherein the identification information is a hash value.

7. The offline game storing system as recited in claim 5, wherein the client further comprises a compressing unit and a decompressing unit, the compressing unit compresses a game progress file to be uploaded, the calculating unit calculates on the compressed game progress file to obtain identification information of the game progress file, and the decompressing unit decompresses a compressed file of the received game progress file.

8. A method for storing a game progress file of an offline game, comprising the following steps:
sending, at a client, a request for uploading a game progress file to a server, wherein the game progress file comprises progress of the offline game played by a user at the client and enables the user to continue the progress of the offline game on a computing device different from the client;
calculating, at the client, on the game progress file to obtain identification information for the game progress file; and
sending to the server the game progress file and its identification information for storage upon determining that the client is allowed by the server to upload the game progress file.

9. The method as recited in claim 8, wherein calculating at the client further comprises terminating a storing process of the game progress file upon determining that the server does not allow the client to upload the game progress file.

10. The method as recited in claim 8, wherein the uploading request comprises game information and user information of the uploading request sent through the client.

11. The method as recited in claim 10, further comprising the following steps between sending at the client and calculating at the client:
receiving and parsing, at the server, the uploading request to obtain information of the user that sends the uploading request through the client;
verifying an identity of the user; and
upon verifying that the identity of the user is legal, allowing the client to upload the game progress file and storing the game information and/or user information to a user information database, or otherwise stopping the storing process of the game progress file.

12. The method as recited in claim 8, wherein calculating at the client further comprising:
compressing, at the client, the game progress file before calculating on the game progress file, and
calculating on the compressed game progress file to obtain the identification information,
wherein upon determining that the offline game is a flash offline game, compressing the game progress file comprises compressing the game progress file from a flash game storing location.

13. The method as recited in claim 12, wherein calculating on the compressed game progress file is a hash calculation, and the identification information obtained is a hash value.

14. The method as recited in claim 8, further comprising the following steps:
receiving, at the server, the game progress file and its identification information;
storing the received identification information to a user information database;
dividing the game progress file into blocks;
storing each block to a node server cluster; and
storing storage information of each block to an index server.

15. The method as recited in claim 14, further comprising the following steps:
after receiving the game progress file, calculating on the received game progress file to obtain second identification information;
comparing the second identification information with the identification information of the game progress file stored in the user information database; and
discarding the received game progress file and delivering a failure notice to the client upon determining that the two identification information are different, or storing each block to a node server cluster upon determining that the two identification information are identical.

16. A method for obtaining a game progress file of an offline game, comprising the following steps:
receiving, at a server from a client, downloading request information for a game progress file, wherein the downloading request information comprises a download address of the game progress, the download address comprises identification information of the game progress file, and the game progress file comprises progress of the offline game played by a user and enables the user to continue the progress of the offline game on a computing device different from the client;
parsing, at the server, the downloading request to obtain the download address and the identification information of the game progress file;
acquiring, via the server, storage information of each block of the game progress file according to the identification information;
obtaining each block of the game progress file according to the storage information, and merging the blocks into a complete game progress file; and
sending to the client the complete game progress file corresponding to the downloading request.

17. The method as recited in claim 16, wherein the complete game progress file is a compressed file, the method further comprising:
decompressing the compressed game progress file and storing the decompressed file to a local storing location of the offline game, and
running the offline game with the progress of the offline game stored in the game progress file,
wherein decompressing the compressed game progress file comprises decompressing the compressed game progress file to a flash game storing location upon determining that the offline game is a flash offline game.

18. The method as recited in claim 16, further comprising the following steps before receiving at the server from the client the downloading request information:
sending a downloading request for a game progress file of a certain game to the server via the client;
carrying out, via the server, identity verification on the user that sends the downloading request via the client; and
sending to the client, via the server, file identifications of all or partial history game progress files of the offline game and for the user upon verifying that the identity is legal, or terminating the process of obtaining the game progress file of the offline game upon determining that the identity is illegal, wherein the file identifications comprise download addresses.

19. The method as recited in claim 18, wherein the file identifications of the history game progress files are sent to the client in the form of a list.

20. The method as recited in claim 18, wherein the identification information of the game progress file is a hash value, and the storage information of each block of the game progress file is corresponding information of the block and its storage location.
